(19) United States
(12) Patent Application Publication
(10) Pub. No.: US 2008/0266770 A1
(43) Pub. Date: Oct. 30, 2008

(54) AUDIO APPARATUS WITH REPLACEABLE PANEL

(75) Inventors: Roman S. Ferber, West Bloomfield, MI (US); Mordechai Lev, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 12/045,287

(22) Filed: Mar. 10, 2008

Related U.S. Application Data
(60) Provisional application No. 60/893,969, filed on Mar. 9, 2007.

(51) Int. Cl. G06F 1/16

(52) U.S. Cl. 361/681

(57) ABSTRACT

An audio apparatus is adapted to receive a portable music device. The apparatus has a housing with a face provided on at least a portion thereof. The housing has an interchangeable panel adapted to be removably mounted on the face of the housing to conceal a portion of the face.

### CROSS-REFERENCE TO RELATED APPLICATIONS

This application claims the benefit of U.S. provisional application Ser. No. 60/893,969 filed Mar. 9, 2007, the disclosure of which is incorporated in its entirety by reference herein.

### BACKGROUND OF THE INVENTION

1. Field of the Invention

This invention relates to an audio apparatus having a replaceable panel.

2. Background Art

An audio apparatus is often employed to provide audio, such as music, for the enjoyment of a user. Various audio functions are generally offered with the audio apparatus to provide varying functions for the user or users. In addition, an audio apparatus may cooperate with a portable music player to provide audio entertainment.

### BRIEF DESCRIPTION OF THE DRAWINGS

FIG. 1 is a perspective view of an embodiment of an audio apparatus with a plurality of replaceable panels;

FIG. 2 is a perspective view of the audio apparatus of FIG. 1 having a replaceable panel mounted thereon;

FIG. 3 is a perspective view of the audio apparatus of FIG. 1 without a replaceable panel mounted thereon;

FIG. 4 is a perspective view of a plurality of replaceable panels;

FIG. 5 is a perspective view of an embodiment of the audio apparatus with a user mounting a replaceable panel thereon;

FIG. 6 is a bottom perspective view of the audio apparatus with the user dismounting the replaceable panel;

FIG. 7 is a perspective view of an embodiment of the audio apparatus with a plurality of replaceable panels;

FIG. 8 is a perspective view of the audio apparatus of FIG. 7 with a replaceable panel dismounted; and

FIG. 9 is a top perspective view of the audio apparatus of FIG. 7 with a replaceable panel mounted thereon.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

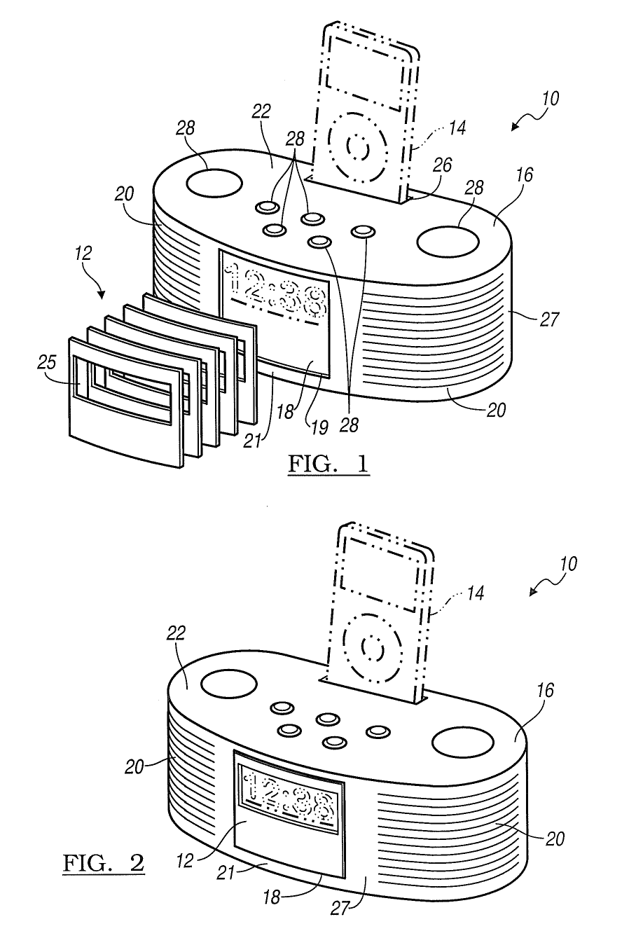

Referring to FIG. 1, an audio apparatus 10 is depicted, wherein audio apparatus 10 may have a plurality of replaceable panels 12. One panel 12 may be mounted on the audio apparatus 10 and may be interchanged with another panel 12. The audio apparatus 10 may be adapted to receive and play sound from a portable music device 14. In one embodiment, the portable music device 14 may be a MP3 player. Any suitable, known MP3 player or other portable muscle device is contemplated within the scope of the present invention. The audio apparatus 10 may charge the portable music device 14 in any suitable, known method. In another embodiment, the audio apparatus 10 may be adapted to fit multiple types of portable music devices 14. The audio apparatus 10 may play sounds, which are calming so that a user may relax and/or fall asleep while listening to the audio apparatus 10. Non-limiting examples of these calming sounds include: ocean, rain, night, waterfall, brook, and sunrise.

Any known audio apparatus 10 may be included in the present invention. In one embodiment, the audio apparatus 10 may include a radio with tuning and volume controls. In another embodiment, the audio apparatus 10 may include a clock and/or an alarm function so that a user can set an alarm on the audio apparatus 10 in order to play sounds from the audio apparatus 10, such as from the portable music device 14, calming sounds, nature sounds, radio sounds, and/or an alarm tone. In still another embodiment, illustrated in FIG. 6, the audio apparatus 10 may have a receptacle 15 to receive an electrical cord (not shown) for electrical communication with other audio devices, such as MP3 players or CD players.

The audio apparatus 10 may be powered by an electric current supplied through a power cable (not shown), which is powered by a standard electrical outlet. In another embodiment, the audio apparatus 10 may be powered by one or more batteries (not shown), which may be rechargeable. Any known power source for an audio apparatus 10 is contemplated within the scope of the present invention.

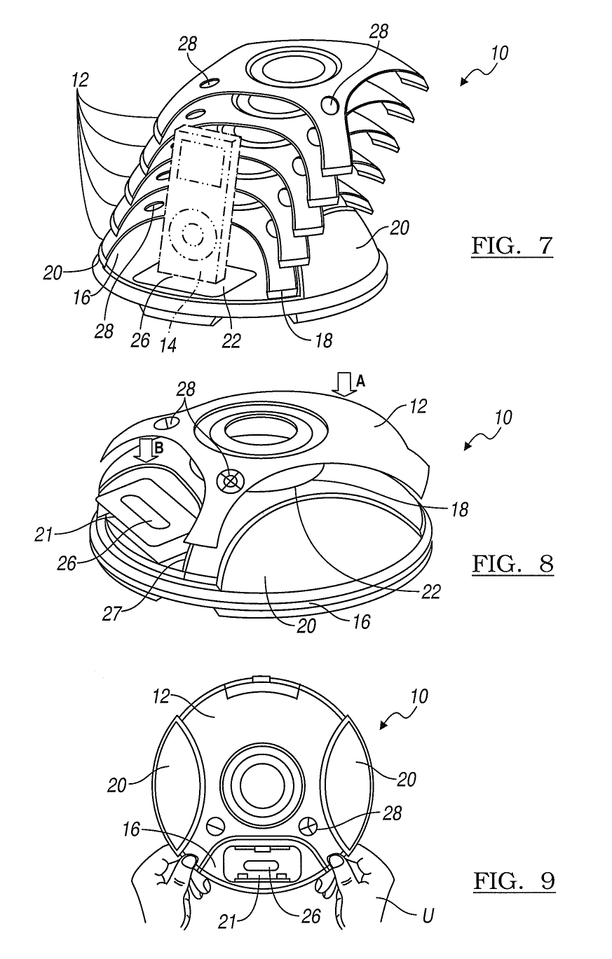

As illustrated, the audio apparatus 10 has a housing 16. Any suitable shape and design for audio apparatus 10 and housing 16 are contemplated within the scope of the present invention. The housing 16 may include a face 18, speakers 20, a front surface 21, an upper surface 22, a bottom surface 23 (depicted in FIG. 6), and a side surface 27 or multiple side surfaces 27. The bottom surface 23 may be adapted to rest on an underlying support surface, such as a table. As shown in FIG. 1, the face 18 may be provided on the front surface 21, or the face 18 may be provided on the upper surface 22, as shown in FIGS. 7-9. Of course, the face 18 may be provided on any of the front surface 21, the upper surface 22 or the side surface 27 or on any combination thereof. As illustrated in FIG. 1, the housing 16 may have an oblong profile when viewed from the upper surface 22. In another non-limiting example, the audio apparatus 10 has a generally circular shape, as shown in FIGS. 7-9.

Referring to FIG. 1, the face 18, with an interchangeable panel or plate 12 mounted thereon, may conceal components located within the housing 16. Each interchangeable panel 12 fits onto the face 18 of the housing 16, and is sized to be received and mounted on the face 18, as illustrated in FIG. 2. Each interchangeable panel 12 may have a color, texture and/or other characteristic in common with the portable music device 14, and a plurality of colors, textures and/or other characteristics for the interchangeable panels 12 may be provided. The interchangeable panel 12 may have any shape or size to correspond with the shape or size of the face 18 of the housing 16. Non-limiting examples of a configuration of the interchangeable panel 12 are illustrated by the multiple interchangeable panels 12 in FIGS. 1, 4 and 7.

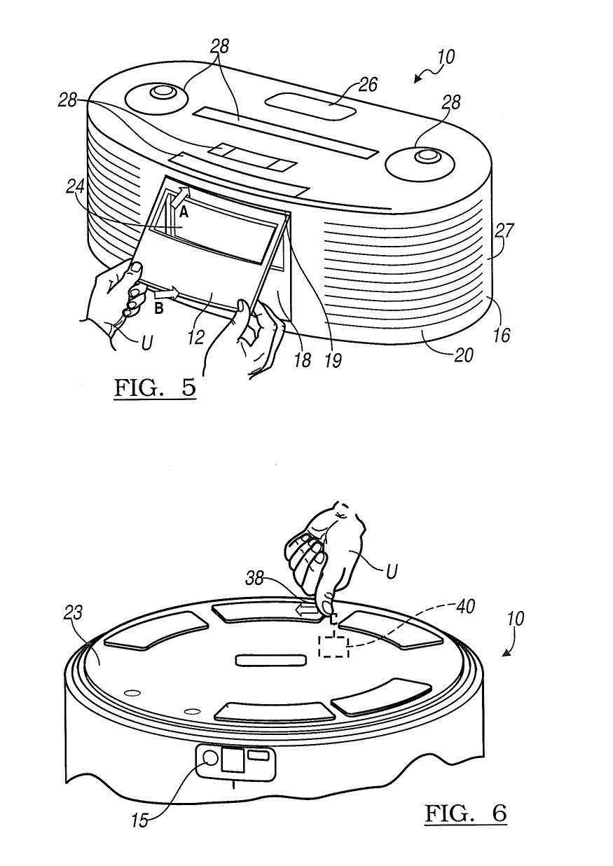

In one embodiment, the face 18 may be recessed within the housing 16 so that the interchangeable panel 12 can be mounted in cooperation with a lip 19 formed between the face 18 and the housing 16. In one embodiment (FIG. 1), the lip 19 may be provided proximate a lower surface 23 of the housing 16. In another embodiment (FIG. 5), the lip 19 may be provided proximate an upper surface 22 of the housing 16. In one embodiment, to mount the interchangeable panel 12 to the face 18, a user may insert a bottom portion of the interchangeable panel 12 into the face 18 of the housing 16 to press against the lip 19. The user may then press upwards and inwards on the interchangeable panel 12 to secure the interchangeable panel 12 in place. While further examples are discussed below with reference to FIGS. 5-6 and 8-9, any securing of the interchangeable panel 12 to the housing 16 is contemplated within the scope of the present invention.

As shown in FIG. 1, the face 18 may also include a display 24. In one embodiment, the display 24 is a digital display or liquid crystal display (LCD), but is not limited thereto. The display 24 may display numbers and/or letters as is known in the art. In the depicted embodiment, a time may be displayed on the display 24. In another embodiment, the display 24 may show a word, such as to indicate a sound setting. The display 24 may also include other ancillary features, such as an indication of an alarm clock being set. The display 24 may have any shape and/or size. The interchangeable panels 12 may have a corresponding aperture 25, which may be sized so that at least a portion the display 24 is visible once the interchangeable panel 12 is placed on the housing 16. Any suitable corresponding size and/or shape for the aperture 25 is contemplated within the scope of the present invention.

In the depicted embodiment, the audio apparatus 10 has speakers 20, which may be located on opposing sides 27 of the housing 16. However, the size and location of the speakers 20 depicted is merely exemplary and should not be taken as a limitation on the present invention. Another example for locations for speakers 20 is illustrated in FIGS. 7-9. The speakers 20 are connected to electrical components (not shown) within the housing 16 to provide sound when activated. The electrical components may then be connected to the portable music device 14 so that the audio apparatus 10 transmits a signal from the portable music device 14 to the speakers 20. In another embodiment, the speakers may play sounds provided by the audio apparatus 10, which are calming. In yet another embodiment, the speakers 20 may play sounds provided by a radio, which is located within the audio apparatus. Although two speakers 20 are illustrated in the present embodiment, any number of speakers 20 is contemplated within the scope of the present invention.

The upper surface 22 of the housing 16 may include an opening 26 to receive the portable music device 14. The opening 26 may sized to receive removable inserts, which are known in the art in order to accommodate portable music devices 14 of varying sizes. The upper surface 22 may also have multiple control buttons 28. The control buttons 28 may be any known power controls, tuning controls, volume controls, time setting controls, sound type controls, alarm setting controls, etc. In another embodiment, the control buttons 28 may be control knobs, which require a user to turn to operate. In yet another embodiment, the control buttons 28 may be a combination of buttons and knobs. Any amount and/or type of control buttons is contemplated within the scope of the present invention. It is also understood that the location of the control buttons 28 is not limited to upper surface 22, but may be disposed anywhere on the housing 16.

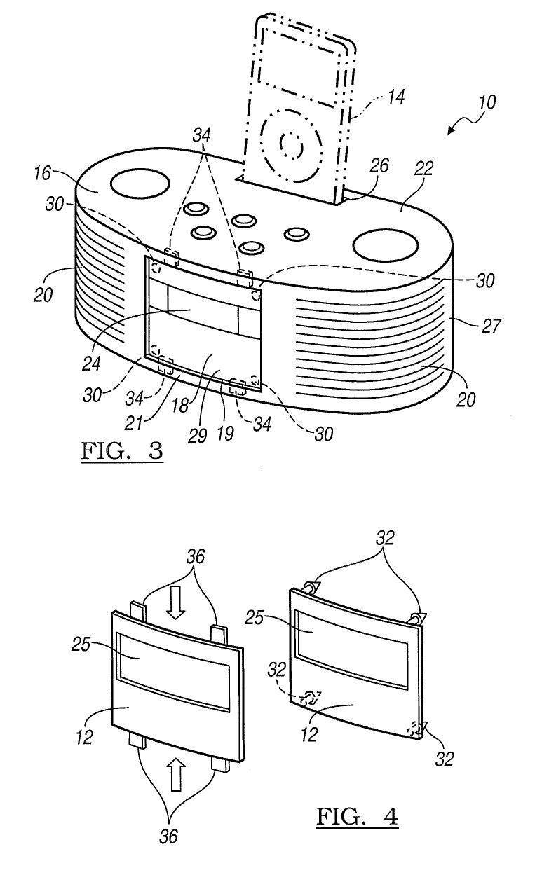

Referring now to FIG. 3, the audio apparatus 10 of FIG. 1 is illustrated with the face 18 uncovered. When uncovered, the exposed portion of the face 18 may include an aperture 29 so that electrical components located within the housing 16 are exposed. In another embodiment, the exposed portion of the face 18 may be the same material as an interior structure for the housing 16. In yet another embodiment, the exposed portion of the face 18 may be fabricated using the same material as the exterior of the housing 16.

In one embodiment, illustrated in FIG. 2, the face 18 may be recessed within the housing 16 so that the interchangeable panel 12 is flush with the housing 16 when mounted thereon. In another embodiment, the face 18 may be flush with the housing so that the interchangeable panel 12 is raised when compared with the housing 16 when mounted. In still another embodiment, both the face 18 and the interchangeable panel 12 can be recessed within the housing 16. In another embodiment, the face 12 may be shaped to follow a corresponding contour of the housing 16. Of course, any suitable orientation for the face 18 and the interchangeable panel 12 is contemplated within the scope of the present invention.

As illustrated, the face 18 of the audio apparatus 10 may include retaining apertures 30. The retaining apertures 30 may receive fasteners 32, which are provided on an embodiment of the interchangeable panel 12 depicted in FIG. 4. The retaining apertures 30 and respective fasteners 32 may be located at corners of the face 18 and interchangeable panel 12 respectively. However, any suitable location, size, and number for the retaining apertures 30 and fasteners 32 is contemplated within the scope of the present invention. As illustrated in FIG. 4, the fasteners 32 may be shafts sized to fit within the apertures 30 of FIG. 3. The fasteners 32 may have flanges, which allow the fastener 32 to pass into the receiving aperture 30 of FIG. 3 while securing the interchangeable panel 12 once the flanges pass through the receiving aperture 30. In one embodiment, the fastener 32 may be a magnet 32 having a magnetic attraction to an opposite magnet provided on or within the housing 16, wherein any number or location of magnets 32 could be utilized. In another embodiment, the fastener 32 may be a screw 32 to cooperate with a retaining aperture 30 provided within the housing 16. It is understood that any suitable fastener 32 is contemplated within the scope of the present invention.

In another embodiment, the housing 16 of FIG. 3 may include tab receiving apertures 34, which correspond with tabs 36 on the interchangeable panel 12 of FIG. 4. The location, size, and number of the apertures 34 and corresponding tabs 36 are not limited to that depicted. Any suitable location and/or size is contemplated within the scope of the present invention. To secure the interchangeable panel 12 to the housing 16, a user may slide the interchangeable panel 12 in the directions indicated by the arrows to fit the interchangeable panel 12 on the face 18. To remove the interchangeable panel 12, a user may again slide the interchangeable panel 12 to release the tabs 36 from the apertures 34. It is understood that tabs 34 may be provided on one side of the interchangeable panel 12 to cooperate with tab receiving apertures 34 while the interchangeable panel 12 snaps into the face 18 at a second end. Of course, other methods of securing and dismounting the interchangeable panel 12 to housing 16 are also contemplated.

Another example of securing the interchangeable panel 12 to the housing 16 is illustrated in FIG. 5. The audio apparatus 10 is illustrated while a user U is mounting an interchangeable panel 12 to the housing 16 of the audio apparatus 10. To mount the interchangeable panel 12 to the face 18, the user U can insert a side of the interchangeable panel 12, such as the top side, into the face 18 of the housing 16, such as along point A. The user U can then press generally firmly on the interchangeable panel 12 to secure the interchangeable panel 12 in place. Any securing of the interchangeable panel 12 to the housing 16 is contemplated within the scope of the present invention.

An embodiment of dismounting the interchangeable panel 12 from the housing 16 is illustrated in FIG. 6. To dismount the interchangeable panel 12 from the face 12 of the housing 16, the user U may press a latch 38 provided on the bottom surface 23 of the housing 16. When the user presses the latch 38, the interchangeable panel 12 may be released from the housing 16 so that the user U can mount another interchangeable panel 12 on the housing 16. Latch 38 may be operably connected to a release mechanism 40, which can engage the interchangeable panel 12 to urge the release of the interchangeable panel 12 from the face 18. Of course, the latch 38 may be provided at any suitable location on the housing 16 to dismount the interchangeable panel in any suitable manner.

Yet another example of securing the interchangeable panel 12 to the housing 16 is illustrated in FIG. 8. To mount the interchangeable panel 12 to the housing 16, the interchangeable panel 12 can be oriented in alignment above the housing 16 as shown. The interchangeable panel 12 can then be mounted on the face 12 of the housing 16, by pressing down on the interchangeable panel 12 near the downward pointing arrows A and subsequently or concurrently pressing down on the interchangeable panel 12 near the downward pointing arrows B. As illustrated, the interchangeable panel 12 is mounted to the upper surface 22 of the housing 16, although any location for the interchangeable panel 12 is possible within the scope of the present invention.

An embodiment of dismounting the interchangeable panel 12 from the housing 16 is depicted in FIG. 9. The user U may press firmly up on the interchangeable panel 12 until a portion of the interchangeable panel 12 is released from the housing 16. Subsequently, the user can grasp the portion of the interchangeable panel 12 to loosen the interchangeable panel 12 from the housing 16. In one embodiment, locking tabs such as those in FIGS. 3-4 may be provided. Of course, any other suitable methods of securing and dismounting the interchangeable panel 12 to housing 16 are also contemplated within the scope of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An audio apparatus adapted to receive a portable music device, the apparatus comprising:
a housing having a face provided on at least a portion thereof; and
an interchangeable panel adapted to be removably mounted on the face of the housing to conceal a portion of the face.

2. The audio apparatus of claim 1, wherein the interchangeable panel includes a color corresponding to a color of the portable music device.

3. The audio apparatus of claim 1, further comprising:
a plurality of interchangeable panels adapted to each be individually and removably mounted on the face of the housing;
wherein the plurality interchangeable panels each have a respective color to correspond with a respective color of a plurality of portable music devices.

4. The audio apparatus of claim 1, wherein the face is provided on a front surface of the housing.

5. The audio apparatus of claim 1, wherein the face is provided on an upper surface of the housing.

6. The audio apparatus of claim 1, wherein the face is provided on a side surface of the housing.

7. The audio apparatus of claim 1, wherein the face includes an aperture formed therein such that electrical components provided within the audio apparatus are exposed when the interchangeable panel is removed.

8. The audio apparatus of claim 1, wherein the housing has an oblong profile.

9. The audio apparatus of claim 1, wherein the housing has a circular profile.

10. The audio apparatus of claim 1, wherein the audio apparatus is adapted to play calming sounds.

11. The audio apparatus of claim 1, wherein the interchangeable panel further comprises at least one fastener provided thereon; and
wherein the housing has at least one retaining aperture provided therein to correspond with the at least one fastener provided on the interchangeable panel and to removably mount the interchangeable panel to the housing.

12. The audio apparatus of claim 11, wherein the at least one fastener of the interchangeable panel is further defined as a shaft having a flange mounted thereon to allow the interchangeable panel to be removably mounted on the housing.

13. The audio apparatus of claim 1, wherein the interchangeable panel further comprises at least one tab provided thereon; and
wherein the housing has at least one tab receiving aperture provided therein to correspond with the at least one tab provided on the interchangeable panel to removably mount the interchangeable panel to the housing.

14. The audio apparatus of claim 13 wherein the at least one tab is further defined as a first tab and a second tab provided at opposite sides of the at interchangeable panel;
wherein the at least one tab receiving aperture is further defined as a first tab receiving aperture and a second tab receiving aperture; and
wherein the interchangeable panel is mounted to and dismounted from the housing by displacing the interchangeable panel in a specified direction.

15. The audio apparatus of claim 1 wherein the housing has a display; and
wherein the interchangeable panel is adapted to be removably mounted over the display of the housing.

16. The audio apparatus of claim 15, wherein the interchangeable panel has an aperture formed therethrough to allow the display to be exposed while at least a portion of the face is concealed.

17. The audio apparatus of claim 1, further comprising a latch provided on the housing to facilitate dismounting the interchangeable panel from the face.

18. An audio apparatus, comprising:
a housing adapted to receive a portable music device, the housing having a face including a display; and
an interchangeable panel adapted to be removably mounted over the display of the housing.

19. The audio apparatus of claim 18, wherein the interchangeable panel has an aperture formed therethrough to allow the display to be exposed while at least a portion of the face is concealed.

20. An audio apparatus, comprising:
a housing adapted to receive a portable music device, the housing having a face including a display; and
a plurality of interchangeable panels adapted to each be individually and removably mounted on the face of the housing while exposing the display and concealing at least a portion of the face, each of the plurality of interchangeable panels having an aperture formed therethrough to allow the display to be exposed while the at least a portion of the face is concealed;
wherein the plurality of interchangeable panels each have respective colors to correspond with respective colors of a plurality of portable music devices.
